(19) United States
(12) Patent Application Publication
(10) Pub. No.: US 2026/0268068 A1
(43) Pub. Date: Sep. 10, 2026

(54) INFORMATION PROCESSING APPARATUS, INFORMATION PROCESSING METHOD, AND COMPUTER PROGRAM

(71) Applicant: SONY GROUP CORPORATION, TOKYO (JP)

(72) Inventor: YASUHARU ASANO, TOKYO (JP)

(21) Appl. No.: 19/166,029

(22) PCT Filed: Jan. 26, 2024
(86) PCT No.: PCT/JP2024/002524

§ 371 Date: Sep. 16, 2025

(30) Foreign Application Priority Data
Mar. 24, 2023 (JP) 2023-048834

(51) Int. Cl. G06F 40/169; G06F 16/38

(52) U.S. Cl. CPC G06F 40/169; G06F 16/38

(57) ABSTRACT

For example, an information processing apparatus that automatically adds a new tag to content of a new genre is provided. An information processing apparatus includes: an existing tag proposal unit that presents, to an annotator, an existing tag appropriate for content to which a tag is to be added from among existing tags; a new tag proposal unit that generates a new tag appropriate for content to which a tag is to be added on the basis of a foundation model and presents the new tag to the annotator in a case where the annotator does not select the existing tag presented by the existing tag proposal unit; and a related content confirmation unit that presents content related to the new tag to the annotator for confirmation.

### TECHNICAL FIELD

The technology disclosed in the present specification (hereinafter, referred to as “present disclosure”) relates to an information processing apparatus, an information processing method, and a computer program that perform processing related to content management.

### BACKGROUND ART

In order to effectively utilize a large amount of content such as music, tags are often added as metadata of the content. Although an annotator manually tags the content, in order to reduce the workload of the annotator, a method of automatically adding a tag using machine learning or the like is considered.

For example, there has been proposed a metadata generation system that automatically generates metadata of video content on the basis of a character code obtained by converting characters constituting a subtitle image displayed in superposition with video content such as television broadcasting by subtitle configuration character recognition and text information obtained by recognizing a voice included in the video content (see Patent Document 1).

### CITATION LIST

### Patent Document

### Patent Document 1: Japanese Patent Application Laid-Open No. 2022-88788

### SUMMARY OF THE INVENTION

### Problems to be Solved by the Invention

An object of the present disclosure is to provide an information processing apparatus, an information processing method, and a computer program that automatically tag content.

### Solutions to Problems

The present disclosure has been made in view of the above problems, and a first aspect thereof is

an information processing apparatus including a new tag proposal unit that generates a new tag appropriate for content to which a tag is to be added on the basis of a foundation model and presents the new tag to an annotator.

The information processing apparatus according to the first aspect further includes an existing tag proposal unit that presents, to an annotator, an existing tag appropriate for content to which a tag is to be added from among existing tags. Then, the new tag proposal unit generates and presents a new tag in a case where the annotator does not select the existing tag presented by the existing tag proposal unit.

Furthermore, the information processing apparatus according to the first aspect further includes a related content confirmation unit that presents content related to the tag to the annotator for confirmation. When the annotator selects the new tag presented by the new tag proposal unit, the related content confirmation unit presents content related to the new tag to the annotator for confirmation.

Furthermore, a second aspect of the present disclosure is

an information processing method including:
an existing tag proposal step of presenting, to an annotator, an existing tag appropriate for content to which a tag is to be added from among existing tags;
a new tag proposal step of generating, in a case where the annotator does not select the existing tag presented in the existing tag proposal step, a new tag appropriate for content to which a tag is to be added on the basis of a foundation model, and presenting the new tag to the annotator; and
a related content confirmation step of presenting content related to the new tag to the annotator for confirmation when the annotator selects the new tag presented in the new tag proposal step.

Furthermore, a third aspect of the present disclosure is

a computer program described in a computer readable format, the computer program causing a computer to function as:
an existing tag proposal unit that presents, to an annotator, an existing tag appropriate for content to which a tag is to be added from among existing tags;
a new tag proposal unit that generates, in a case where the annotator does not select the existing tag presented by the existing tag proposal unit, a new tag appropriate for content to which a tag is to be added on the basis of a foundation model, and presents the new tag to the annotator; and
a related content confirmation unit that presents content related to the new tag to the annotator for confirmation.

The computer program according to the third aspect of the present disclosure is obtained by defining a computer program described in a computer readable format in such a way as to implement predetermined processing on a computer. The computer program can be provided for a computer capable of executing various program codes by a storage medium provided in a computer-readable form, a communication medium, a storage medium such as an optical disk, a magnetic disk, or a semiconductor memory, for example, or a communication medium such as a network. Then, by installing the computer program according to the third aspect of the present disclosure in a computer via any of the media, a cooperative action is exerted on the computer, and operational effects similar to those of the information processing apparatus according to the first aspect of the present disclosure can be achieved.

### Effects of the Invention

According to the present disclosure, it is possible to provide an information processing apparatus, an information processing method, and a computer program that automatically add a new tag to content.

Note that the effects described in the present specification are merely examples, and the effects to be brought by the present disclosure are not limited thereto. Furthermore, there are cases where the present disclosure further provides some other effects, in addition to the effects described above.

Still other objects, features, and advantages of the present disclosure will become apparent from a more detailed description based on embodiments as described later and the accompanying drawings.

### BRIEF DESCRIPTION OF DRAWINGS

FIG. 1 is a diagram illustrating a basic configuration of a tag adding system 100 that adds a tag to content.

FIG. 2 is a flowchart illustrating a processing procedure for adding a tag to content on the tag adding system 100.

FIG. 3 is a flowchart illustrating another processing procedure for adding a tag to content on the tag adding system 100.

FIG. 4 is a diagram illustrating a modification of the flowchart illustrated in FIG. 3.

FIG. 5 is a diagram illustrating an annotation screen example.

FIG. 6 is a diagram illustrating an annotation screen example.

FIG. 7 is a diagram illustrating an annotation screen example.

FIG. 8 is a diagram illustrating an annotation screen example.

FIG. 9 is a diagram illustrating an annotation screen example.

FIG. 10 is a diagram illustrating an annotation screen example.

FIG. 11 is a diagram illustrating an annotation screen example.

FIG. 12 is a diagram illustrating a configuration example of an information processing apparatus 2000.

### MODE FOR CARRYING OUT THE INVENTION

Hereinafter, embodiments of the present disclosure will be described with reference to the drawings in the following order.
A. Outline
B. Foundation Model
C. Basic Configuration
D. Processing Procedure
D-1. Processing Example (1)
D-2. Processing Example (2)
E. Annotation Screen Examples
E-1: Annotation Screen Example (1)
E-2: Annotation Screen Example (2)
F. Configuration of Information Processing Apparatus

### A. Outline

For example, automatic tagging of content can be realized by using a model subjected to machine learning to estimate a tag from content. If the number of samples for learning is large, machine learning for more appropriate tagging can be performed. Conversely, automation of tagging by machine learning is difficult with a small number of samples.

For example, in the music industry, music of a new genre is produced one after another, but in the case of content of a new genre, since the number of samples is small, it is difficult to automate tagging by machine learning. Furthermore, since the tag is abstract in the first place, there is an individual difference in interpretation of the tag for each annotator in a case where the annotator manually performs tagging. The tags attached to the same music are different for each annotator, and effective use of content using the tags (content classification and management) becomes difficult. Furthermore, if the annotator freely adds tags, the number of tags increases, or there are a lot of similar tags, so that it becomes difficult for the user who searches and recommends content using the annotator itself and the tag to grasp the content from the tag.

In short, it is desired to automatically add a new tag that is not similar to an existing tag to content of a new genre, but it is difficult to perform machine learning from a small number of samples. When the number of samples is small, the accuracy of the model is not improved, so that it is also difficult to add a new tag to existing content.

Therefore, the present disclosure proposes a technology for automatically adding a new tag to content using a foundation model learned with a large-scale sample. Since the foundation model is used, learning can be performed so that an appropriate tag can be generated even with a small number of samples.

According to the present disclosure, it is possible to propose a tag to be added to content using the foundation model, and thus, it is possible to absorb individual differences in tag interpretation by the annotator. Furthermore, according to the present disclosure, it is possible to propose related content to an annotator and refine a tag to be added to the content on the basis of selection of the annotator for the content. At the same time, by increasing the number of content samples associated with the new tag, the new tag can be incorporated into the existing tag system to enrich the system.

Therefore, according to the present disclosure, it is possible to add a tag that hardly causes a difference in interpretation to content (particularly, content of a new genre) using the foundation model having language knowledge, and thus, it is possible to reduce a burden on the annotator. Furthermore, according to the present disclosure, it is possible to add sophisticated tags to content of new genres and existing genres, and thus, it is possible to manage various content with a smaller number of tags by suppressing the randomization of similar tags that may occur in a case where tagging is performed with the sensitivity of the annotator.

### B. Foundation Model

The present disclosure has one feature in using a siner that automatically generates a new and appropriate tag to be added to content. In this section B, the foundation model will be described.

In conventional machine learning represented by deep learning, a method of performing learning using a sample with a correct answer label according to an application is common. In such a case, it is necessary to prepare a certain amount of samples for learning. Recently, a method of obtaining a highly accurate model by preparing a model obtained by preparing a large number of unsupervised samples in advance and performing self-supervised learning as a preliminary learning model and then performing fine tuning according to an application has become mainstream.

The foundation model is a model in which the direction of the latter method is further advanced, a huge amount of unsupervised samples are prepared, and self-supervised learning is performed, and a general-purpose model is constructed from large-scale data, and the general-purpose model is further customized according to the application.

One of the most famous examples of the foundation model is GPT-3 developed and published by OpenAI. GPT-3 is a model that learns 175 billion parameters using a large amount of unsupervised text data (45TB). The GPT-3 can be used for various applications of natural language such as generation, summarization, question response, and translation of sentences by devising a utilization method thereof. For example, a method has been studied in which necessary information is devised in the form of a prompt, provided to a foundation model, and information generated to solve a problem is exemplified, thereby appropriately solving the problem without changing parameters of the model itself.

The GPT-3 described above is an example of a foundation model specialized in text processing, but there is also a foundation model in which learning is performed with a very large number of samples by combining image information, voice or music information, and a relationship between these and text, and research and development of a foundation model for generating an image and a sound from text is also energetically performed.

For example, DALLE-2 is a foundation model developed and published by OpenAI to generate an image from text. Furthermore, AudioGen is a foundation model for generating sound from text. It is considered that these foundation models potentially hold not only text character strings but also relationships between image feature amounts and sound feature amounts in a huge parameter space through learning using a huge amount of samples. Therefore, the foundation model can utilize such relationships to generate bidirectionally between text and images and between text and sound.

### C. Basic Configuration

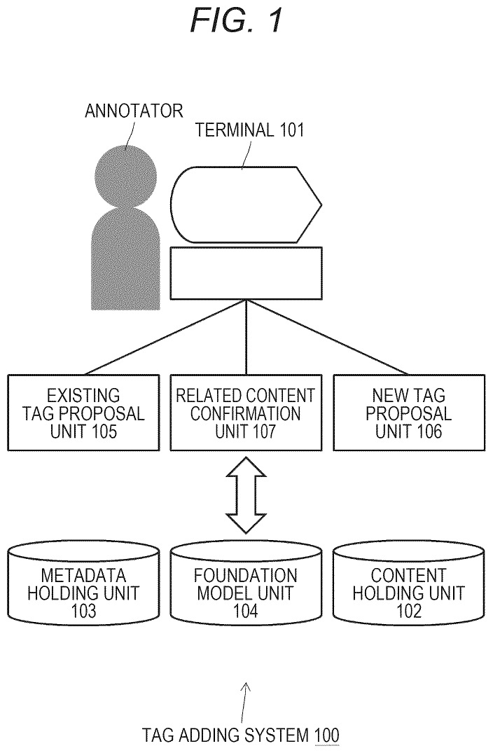

FIG. 1 schematically illustrates a basic configuration of a tag adding system 100 that adds a tag to content. The tag adding system 100 may be configured as a part of a content editing system that performs various processing related to content editing, for example.

The terminal 101 is a device that performs input/output operations for an annotator to add a tag to content, and includes a display and a console such as a keyboard, a mouse, and a touch panel. Furthermore, it is assumed that the terminal 101 also has a function of playing content to which a tag is to be added.

The content holding unit 102 is a database that holds content to be tagged, such as text, audio, and image. For example, in a case where new content is created/edited by a content editing system (not illustrated), the new content is appropriately added to the content holding unit 102. For example, in the music content, a new song is appropriately added to the content holding unit 102.

The metadata holding unit 103 is a database that holds a tag related to content as metadata. The metadata holding unit 103 stores the tag added to the content held in the content holding unit 102 in association with the content.

The foundation model unit 104 holds foundation models related to text media and content media.

The existing tag proposal unit 105 presents an appropriate tag for content to which a tag is to be added from among existing (registered) tags via the terminal 101. The existing tag proposal unit 105 estimates a tag appropriate for target content, for example, using a DNN model learned using a sample with a correct answer label. From the DNN model, a tag appropriate for the content is estimated from among existing (registered) tags learned as correct answer labels, and no new tag is generated.

Using the foundation model held in the foundation model unit 104, the new tag proposal unit 106 generates a plurality of candidates for text information appropriate as a new tag related to content to which a tag is to be added, and presents the candidates to the annotator via the terminal 101. The new tag proposal unit 106 generates a word or phrase appropriate to the tag as text information.

When the annotator adopts the new tag proposed by the new tag proposal unit 106, the related content confirmation unit 107 presents related content via the terminal 101 and requests the annotator to confirm the content. This is because the newly generated tag corresponds to not only one target content but also other related content, and may be suitable for a tag of other content. The related content confirmation unit 107 presents a plurality of pieces of content related to the new tag to the annotator, and causes the annotator to select which content's tag is appropriate. As a result, it is possible to comprehensively associate the content corresponding to the new tag.

The content holding unit 102, the metadata holding unit 103, the foundation model unit 104, the existing tag proposal unit 105, the new tag proposal unit 106, and the related content confirmation unit 107 may be arranged in a cloud server, and may provide an automatic tagging service for content to the terminal 101 as a client. Alternatively, the terminal 101, the content holding unit 102, the metadata holding unit 103, the foundation model unit 104, the existing tag proposal unit 105, the new tag proposal unit 106, and the related content confirmation unit 107 may all be arranged in a single device.

### D. Processing Procedure

Next, a processing operation for adding a tag to content in the tag adding system 100 will be described.

### D-1. Processing Example (1)

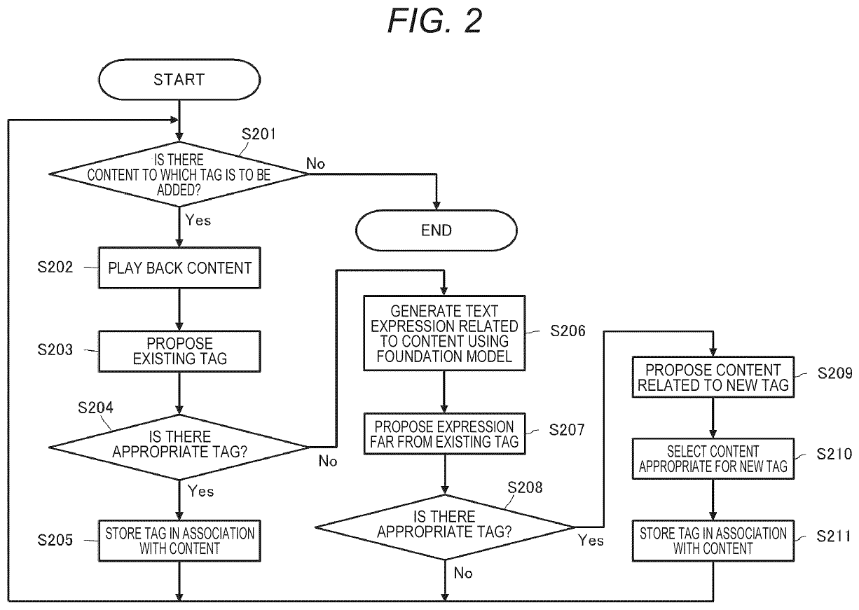

FIG. 2 illustrates a processing procedure for adding a tag to content on the tag adding system 100 in the form of a flowchart.

In a case where there is content to which a tag is to be added among the content held in the content holding unit 102 (Yes in step S201), the annotator selects the content and plays back the content on the terminal 101 (step S202). In the case of text or image content, the content is displayed on the display of the terminal 101, and in the case of sound content, the content is played back by the speaker of the terminal 101. Note that, in a case where there is no content to which a tag is to be added (No in step S201), this processing ends.

In step S201, the annotator selects, for example, new content added to the content holding unit 102 as content to which a tag is to be added. For example, in the music content, a new song added to the content holding unit 102 is selected.

Next, the existing tag proposal unit 105 presents one or a plurality of tags appropriate for the content selected in step S202 from among the registered tags via the terminal 101 (step S203). The existing tag proposal unit 105 estimates a tag appropriate for the content using the DNN model learned using the sample with a correct answer label.

In a case where an appropriate tag for the content selected in step S202 is found from among the existing tags presented by the existing tag proposal unit 105 in step S203 (Yes in step S204), the annotator selects the tag via the terminal 101. In this case, the metadata holding unit 103 stores the tag in association with the corresponding content in the content holding unit 102, assuming that the tag selected in step S204 is added to the content (step S205).

Thereafter, the processing returns to step S201, and the above-described processing is repeatedly executed until there is no content to which a tag is to be added from the content holding unit 102 (alternatively, until tag addition is completed for all the held content).

On the other hand, in a case where an appropriate tag for the content selected in step S202 has not been found from among the tags presented by the existing tag proposal unit 105 in step S203 (No in step S204), subsequently, the new tag proposal unit 106 generates a plurality of candidates for text information (word, phrase) appropriate as a new tag related to the content to which a tag is to be added, using the foundation model held in the foundation model unit 104 (step S206). Then, the new tag proposal unit 106 selects an expression that is semantically far from the existing tag presented by the existing tag proposal unit 105 in step S203 from the plurality of generated candidates, and presents the expression to the annotator via the terminal 101 (step S207).

In a case where the annotator has not been able to find an appropriate tag for the content selected in step S202 from among the tags presented by the new tag proposal unit 106 in step S207 (No in step S208), the annotator gives up tagging of this content. Then, the processing returns to step S201, and the above-described processing is repeatedly executed until there is no content to which a tag is to be added from the content holding unit 102 (alternatively, until tag addition is completed for all the held content).

On the other hand, in a case where an appropriate tag for the content selected in step S202 is found from among the tags presented by the new tag proposal unit 106 in step S207 (Yes in step S208), the annotator selects the new tag via the terminal 101.

When the annotator selects the new tag proposed by the new tag proposal unit 106, there is a possibility that the new tag may correspond to other content. This is because the newly generated tag corresponds to not only one target content but also other related content, and may be suitable for a tag of other content. Therefore, the related content confirmation unit 107 presents the content related to the new tag selected in step S208 via the terminal 101 (step S209), and requests the annotator to confirm the content.

The annotator selects content that is more appropriate for the new tag selected in step S208 from among the plurality of pieces of related content presented (step S210). Then, the metadata holding unit 103 stores the new tag selected by the annotator in step S208 in association with the content selected in step S210 (step S211).

In this manner, the related content confirmation unit 107 presents a plurality of pieces of content related to the new tag to the annotator, and causes the annotator to select whether the newly generated tag is appropriate for any content, whereby the new tag can be comprehensively associated with the content. Moreover, regarding a content sample to be associated with a tag, the DNN model can be learned with the association as a correct label, and added as an existing tag.

Thereafter, the processing returns to step S201, and the above-described processing is repeatedly executed until there is no content to which a tag is to be added from the content holding unit 102 (alternatively, until tag addition is completed for all the held content).

Note that, in step S207 in the flowchart illustrated in FIG. 2, processing of selecting a tag having a semantically far expression is performed, but a method of selecting a tag having a semantically far expression will be supplemented.

In natural language processing, a method of converting a language expression (word, phrase, sentence, document) that is a symbol sequence into a vector expression and defining a distance between the vectors is generally known. Also in step S207 described above, each tag can be converted into a vector representation, and the perspective of the semantic representation between the tags can be determined on the basis of the distance between the vectors.

As a method of vectorizing the language representation, for example, the following methods have been proposed so far, and these methods may be used, or vectorization (embedding) can be performed using a part of the internal representation of the foundation model.
(1) Bag of Words
(2) Latent Semantic Indexing, Latent Direchlet Allocation
(3) Word2vec

Furthermore, as a distance definition between vectors, for example, a Euclidean distance and a cosine similarity can be exemplified. In the present embodiment, after each tag is converted into a vector representation, the perspective of the distance is quantified on the basis of the Euclidean distance or the cosine similarity between the vectors, whereby a tag that becomes a semantically far expression can be selected.

### D-2. Processing Example (2)

In the flowchart illustrated in FIG. 2, a processing procedure is performed in which a new tag is added in a case where there is no existing tag appropriate for content to which a tag is to be added. However, the existing tag and the new tag can be presented in parallel as tag candidates.

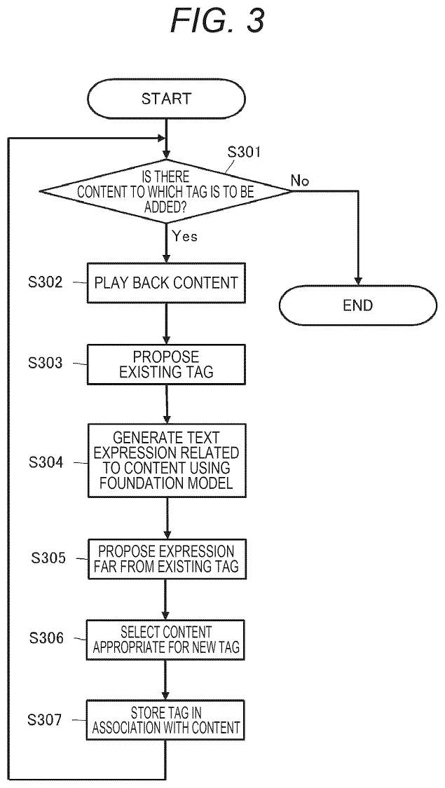

FIG. 3 illustrates a processing procedure in a case where an existing tag and a new tag are added in parallel in the form of a flowchart.

In a case where there is content to which a tag is to be added among the content held in the content holding unit 102 (Yes in step S301), the annotator selects the content and plays back the content on the terminal 101 (step S302). In the case of text or image content, the content is displayed on the display of the terminal 101, and in the case of sound content, the content is played back by the speaker of the terminal 101. Note that, in a case where there is no content to which a tag is to be added (No in step S301), this processing ends.

In step S301, the annotator selects, for example, new content added to the content holding unit 102 as content to which a tag is to be added. For example, in the music content, a new song added to the content holding unit 102 is selected.

Next, the existing tag proposal unit 105 presents one or a plurality of tags appropriate for the content selected in step S302 from among the registered tags via the terminal 101 (step S303). The existing tag proposal unit 105 estimates a tag appropriate for the content to the annotator using the DNN model learned using the sample with a correct answer label.

Subsequently, the new tag proposal unit 106 generates a plurality of candidates for text information (word, phrase) appropriate as a new tag related to content to which a tag is to be added, using the foundation model held in the foundation model unit 104 (step S304). Then, the new tag proposal unit 106 selects an expression that is semantically far from the existing tag presented by the existing tag proposal unit 105 in step S303 from the plurality of generated candidates, and presents the expression to the annotator via the terminal 101 (step S305). In step S305, after converting each tag into a vector expression, the new tag proposal unit 106 calculates an inter-vector distance such as Euclidean distance and cosine similarity, and selects a new tag that is an expression semantically far from the existing tag (same as above).

The annotator selects a tag suitable for the content selected in step S302 from the existing tag presented by the existing tag proposal unit 105 in step S303 and the new tag presented by the new tag proposal unit 106 in step S305 via the terminal 101 (step S306). Then, the metadata holding unit 103 stores the tag selected in step S306 in association with the content selected in step S302 (step S307).

Thereafter, the processing returns to step S301, and the above-described processing is repeatedly executed until there is no content to which a tag is to be added from the content holding unit 102 (alternatively, until tag addition is completed for all the held content).

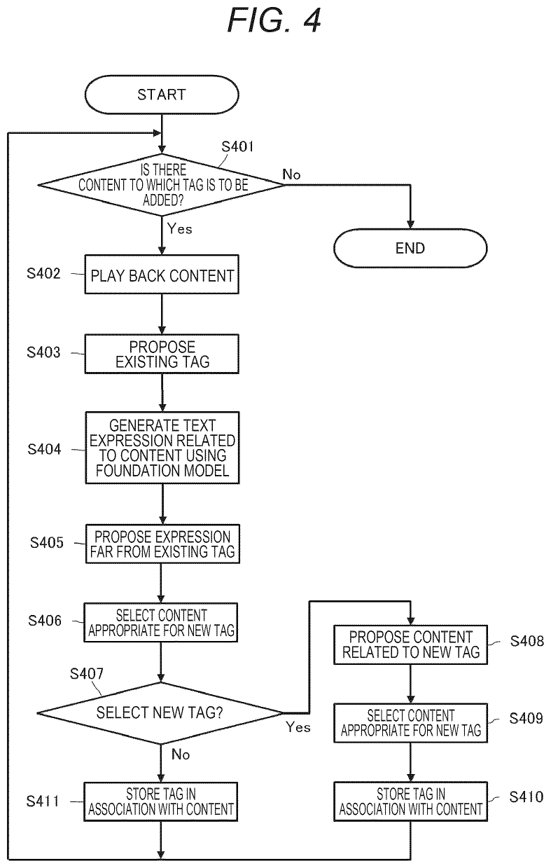

FIG. 4 illustrates a modification of the processing procedure illustrated in FIG. 3 in the form of a flowchart. The processing procedure illustrated in FIG. 4 is the same as the processing procedure illustrated in FIG. 3 in that the existing tag and the new tag are added in parallel, but is different in that when the annotator selects the new tag proposed by the new tag proposal unit 106, processing of checking related content related to the new tag is added.

Steps S401 to S406 in the flowchart illustrated in FIG. 4 are common to steps S301 to S306 in the flowchart illustrated in FIG. 3, and thus description thereof is omitted here.

In a case where the annotator selects the new tag presented by the new tag proposal unit 106 in step S406 (Yes in step S407), there is a possibility that the new tag corresponds to other content (the same as above). Therefore, the related content confirmation unit 107 presents the content related to the new tag selected in step S407 via the terminal 101 (step S408), and requests the annotator to confirm the content.

The annotator selects content that is more appropriate for the new tag selected in step S406 from among the plurality of pieces of related content presented (step S409). Then, the metadata holding unit 103 stores the new tag selected by the annotator in step S406 in association with the content selected in step S409 (step S410).

In this manner, the related content confirmation unit 107 presents a plurality of pieces of content related to the new tag to the annotator, and causes the annotator to select whether the newly generated tag is appropriate for any content, so that it is possible to comprehensively associate the content corresponding to the new tag.

On the other hand, in a case where the annotator selects only the existing tag presented by the existing tag proposal unit 105 in step S406 (No in step S407), the metadata holding unit 103 stores the existing tag selected by the annotator in step S406 in association with the content selected in step S409 (step S411).

Thereafter, the processing returns to step S401, and the above-described processing is repeatedly executed until there is no content to which a tag is to be added from the content holding unit 102 (alternatively, until tag addition is completed for all the held content).

### E. Annotation Screen Examples

In this section E, a configuration example of an annotation screen displayed on the display, which is used when the annotator performs an operation of adding a tag to content on the terminal 101, will be described. However, in the following, a case where music content is set as content to which a tag is to be added will be described.

### E-1. Annotation Screen Example (1): Case of Adding Tags in Order of Existing Tag and New Tag

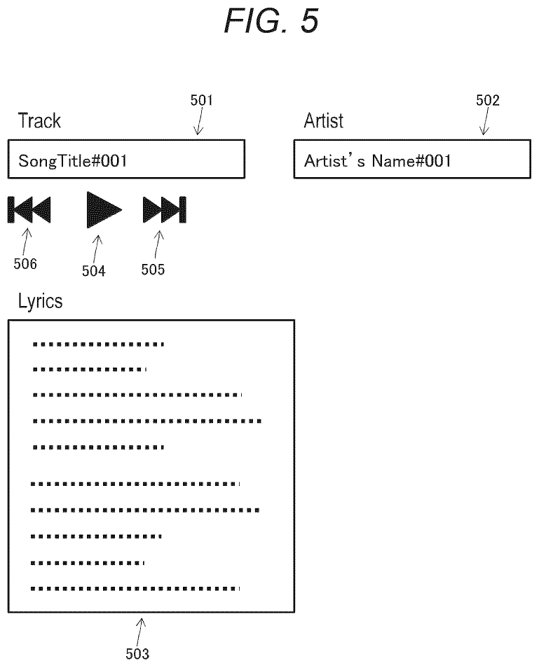

First, according to the flowchart illustrated in FIG. 2, annotation screens in the case of tagging content with an existing tag and a new tag in this order will be described with reference to FIGS. 5 to 8.

On the annotation screen illustrated in FIG. 5, the annotator inputs a song title of a music content to which a tag is to be added in a song title (Track) field 501. In a case where the song title input in the song title field 501 is hit with the music content held in the content holding unit 102, the singer name and the lyrics of the music content are displayed in a singer name (Artist) field 502 and a lyrics (Lyrics) field 503, respectively. Note that, in the song title (Track) field 501, a desired track name may be input as text, or each song title of the music content held in the content holding unit 102 may be displayed in a pull-down menu. Then, the annotator can actually listen to and confirm the music content by performing a playback operation of the selected music content using a playback button 504, a fast-forward button 505, and a rewind button 506 immediately below the song title field 501.

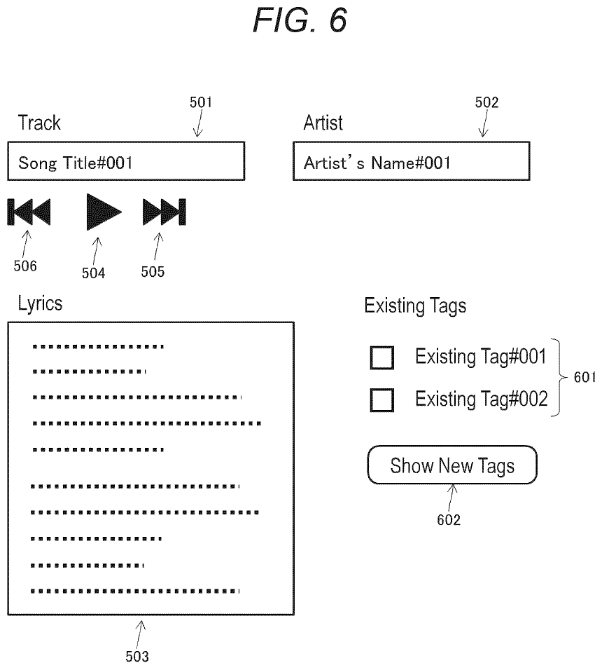

Next, the existing tag proposal unit 105 estimates one or a plurality of existing tags appropriate for the music content selected in the song title field 501. Then, as illustrated in FIG. 6, on the annotation screen, a list 601 of existing tags proposed by the existing tag proposal unit 105 is displayed, and a new tag presentation (Show New Tag) button 602 requesting presentation of a new tag is further displayed. A check box is provided in each existing tag in the list 601 of existing tags.

In a case where an appropriate existing tag is found for the music content selected in the song title field 501, the annotator can indicate tag addition to the music content by checking a check box. On the other hand, in a case where the annotator cannot find an appropriate existing tag for the music content selected in the song title field 501, the annotator can instruct the new tag proposal unit 106 to present the new tag by pressing the new tag presentation (Show New Tag) button 602.

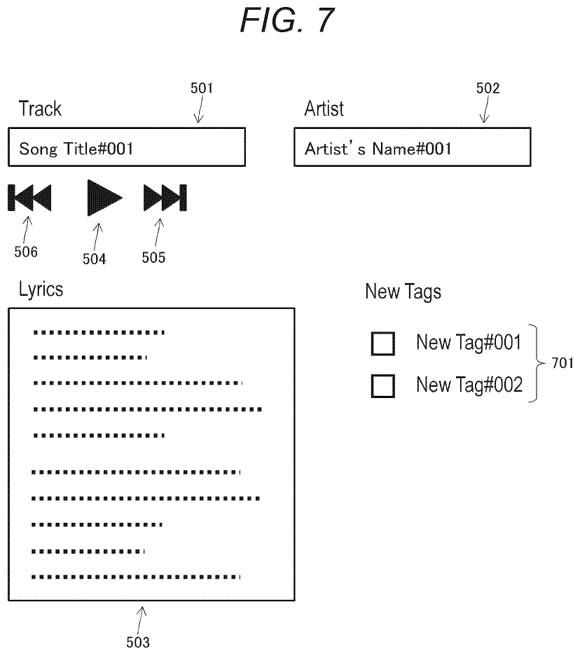

In response to an instruction from the annotator, the new tag proposal unit 106 generates a plurality of candidates of text information (word, phrase) appropriate for the music content selected in the song title field 501 using the foundation model held in the foundation model unit 104, and selects an expression that is semantically far from the existing tag 601 presented by the existing tag proposal unit 105. Then, as illustrated in FIG. 7, a list 701 of new tags that are semantically far from the existing tag 601 is displayed on the annotation screen. A check box is provided in each new tag in the list 701 of new tags.

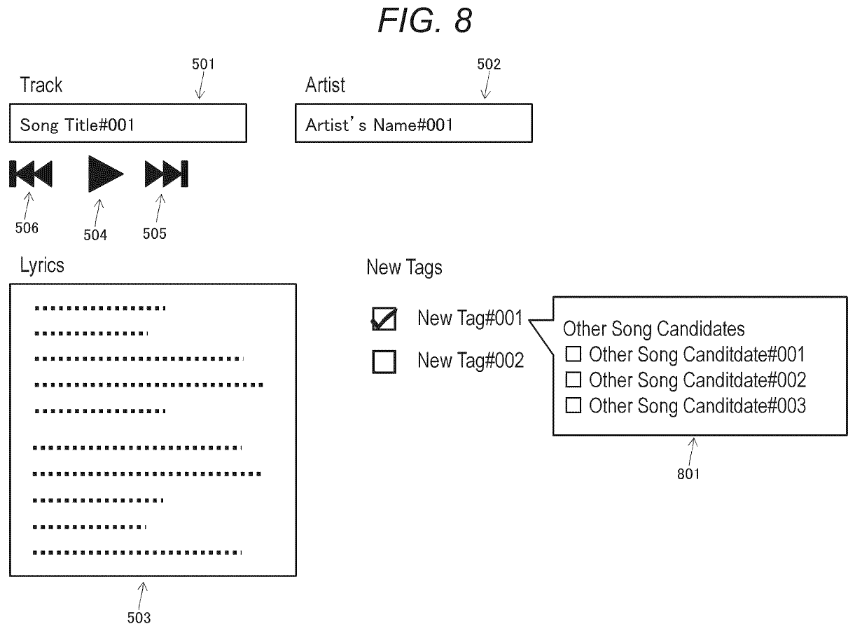

In a case where an appropriate new tag is found for the music content selected in the song title field 501, the annotator can indicate tag addition to the music content by checking a check box. When any new tag in the list 701 of new tags is selected on the annotation screen illustrated in FIG. 7, as illustrated in FIG. 8, the related content confirmation unit 107 further displays a pop-up window 801 listing titles of content related to the selected new tag, and requests the annotator to confirm the content. This is because the newly generated tag corresponds to not only one target content but also other related content, and may be suitable for a tag of other content. At this time, it is more preferable to be able to play back music and display lyrics so that the content of the content can be confirmed by clicking the title of the displayed content. A check box is provided in the title of each content listed in the pop-up window 801.

In a case where the title of the content considered to be more appropriate for the selected new tag is found from the pop-up window 801, the annotator checks a check box and selects the content. Then, the metadata holding unit 103 stores the new tag selected by the annotator in association with the content selected from the pop-up window 801.

### E-2. Annotation Screen Example (2): Case of Adding Existing Tag and New Tag in Parallel

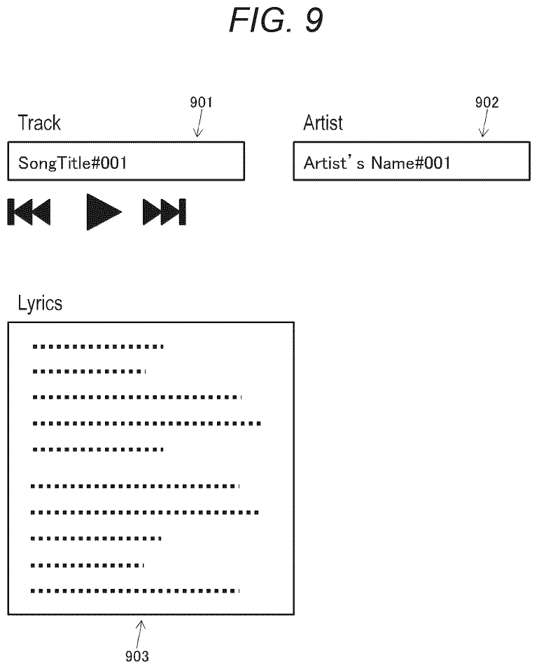

Next, following the flowchart illustrated in FIG. 3, annotation screens in a case where the existing tag and the new tag are tagged to content in parallel will be described with reference to FIGS. 9 to 11.

On the annotation screen illustrated in FIG. 9, the annotator inputs a song title of a music content to which a tag is to be added in a song title (Track) field 901. In a case where the song title input in the song title field 901 is hit with the music content held in the content holding unit 102, the singer name and the lyrics of the music content are displayed in a singer name (Artist) field 902 and a lyrics (Lyrics) field 903, respectively (same as above).

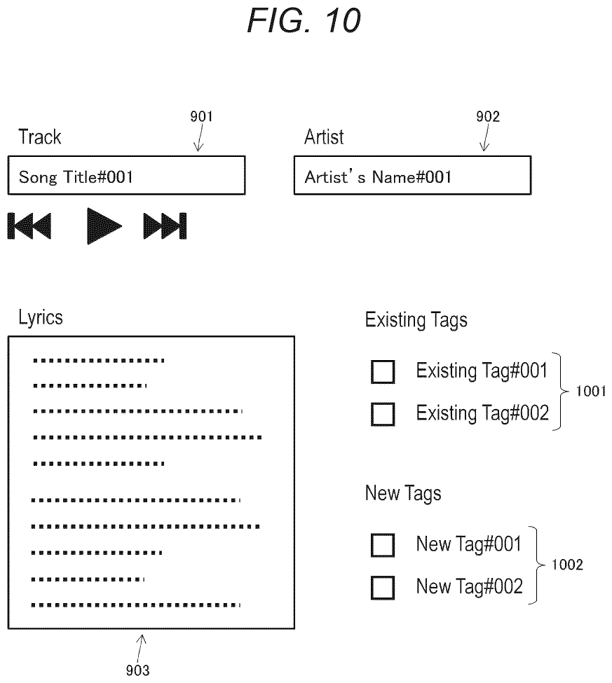

Next, the existing tag proposal unit 105 estimates one or a plurality of existing tags appropriate for the music content selected in the song title field 901. Furthermore, the new tag proposal unit 106 the new tag proposal unit 106 selects, from among the plurality of tag candidates generated using the foundation model held in the foundation model unit 104, a tag that is semantically far from the existing tag estimated by the existing tag proposal unit 105. Then, as illustrated in FIG. 10, on the annotation screen, a list 1001 of existing tags proposed by the existing tag proposal unit 105 and a list 1002 of new tags proposed by the new tag proposal unit 106 are displayed in parallel. A check box is provided in each tag of the list 1001 of existing tags and the list 1002 of new tags. In a case where the appropriate tag is found for the musical content selected in the song title field 901, the annotator can indicate the tag addition to the musical content by checking the check box.

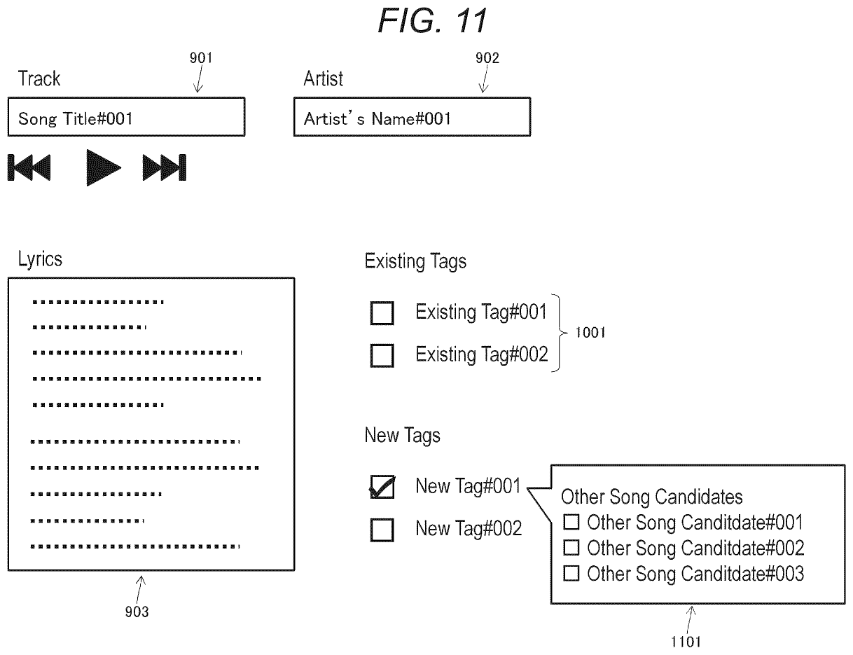

When any new tag in the list 1002 of new tags is selected, as illustrated in FIG. 11, the related content confirmation unit 107 further displays a pop-up window 1101 listing titles of content related to the selected new tag, and requests the annotator to confirm the content. This is because the newly generated tag corresponds to not only one target content but also other related content, and may be suitable for a tag of other content. A check box is provided in the title of each content listed in the pop-up window 1101.

In a case where the title of the content considered to be more appropriate for the selected new tag is found from the pop-up window 1101, the annotator checks a check box and selects the content. Then, the metadata holding unit 103 stores the new tag selected by the annotator in association with the content selected from the pop-up window 1101.

Expressions such as “broken heart” and “lost love” can be considered as a tag indicating a love break for a music content singing a love break. If the annotator is allowed to freely add a tag, there is a concern that a plurality of tags representing a similar concept is set particularly in a case where a plurality of annotators performs work, and the entire metadata becomes unclear. By adding a new tag generated using the foundation model to the music content as in the present disclosure, it is possible to suppress such disorder of similar tags, and as a result, it is possible to manage various contents with a smaller number of tags as metadata.

### F. Configuration of Information Processing Apparatus

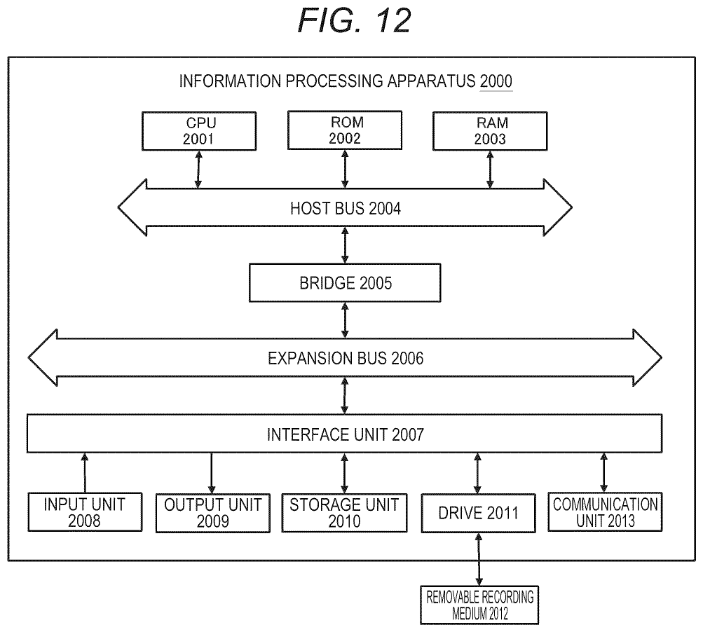

In this section F, an information processing apparatus that is used in implementing the present disclosure is described. FIG. 12 illustrates a configuration example of the information processing apparatus 2000. The information processing apparatus 2000 can constitute the entire tag adding system 1000 or a part thereof. The information processing 2000 can constitute, for example, any one or two or more of the existing tag proposal unit 105, the new tag proposal unit 106, and the related content confirmation unit 107. Furthermore, the information processing apparatus 2000 can also constitute the terminal 101 operated by the annotator.

The information processing apparatus 2000 illustrated in FIG. 12 includes a central processing unit (CPU) 2001, a read only memory (ROM) 2002, a random access memory (RAM) 2003, a host bus 2004, a bridge 2005, an expansion bus 2006, an interface unit 2007, an input unit 2008, an output unit 2009, a storage unit 2010, a drive 2011, and a communication unit 2013.

The CPU 2001 controls the overall operation of the information processing apparatus 2000 according to various programs. The ROM 2002 stores programs (such as a basic input/output system) and computation parameters to be used by the CPU 2001 in a nonvolatile manner. The RAM 2003 is used to load a program to be used in execution of the CPU 2001 and temporarily store parameters such as work data that appropriately changes during program execution. Examples of the program to be loaded into the RAM 2003 and executed by the CPU 2001 include various application programs, an operating system (OS), and the like.

The CPU 2001, the ROM 2002, and the RAM 2003 are interconnected by the host bus 2004 including a CPU bus or the like. Then, the CPU 2001 operates in conjunction with the ROM 2002 and the RAM 2003 to execute various application programs under an execution environment provided by the OS, thereby enabling various functions and services to be implemented. In a case where the information processing apparatus 2000 is a personal computer, the OS is, for example, Windows (registered trademark), Unix (registered trademark) or the like of Microsoft Corporation in the US. Furthermore, the application program includes a program for operating as at least one of the existing tag proposal unit 105, the new tag proposal unit 106, or the related content confirmation unit 107. Furthermore, the application program may also include a program to operate as terminal 101 operated by the annotator (or displays the annotation screens illustrated in FIGS. 5 to 12).

The host bus 2004 is connected to the expansion bus 2006 via the bridge 2005. The expansion bus 2006 is, for example, a peripheral component interconnect (PCI) bus or PCI Express, and the bridge 2005 is based on the PCI standard. However, the information processing apparatus 2000 does not necessarily have a configuration in which circuit components are separated by the host bus 2004, the bridge 2005, and the expansion bus 2006, and may be designed in such a manner that almost all circuit components are interconnected by a single bus (not illustrated).

The interface unit 2007 connects peripheral devices such as the input unit 2008, the output unit 2009, the storage unit 2010, the drive 2011, and the communication unit 2013 according to the standard of the expansion bus 2006. Note that all of the peripheral devices illustrated in FIG. 9 are not necessarily essential, and the information processing apparatus 2000 may further include a peripheral device not illustrated in the drawing. Furthermore, the peripheral device may be built in the main body of the information processing apparatus 2000, or some peripheral devices may be externally connected to the main body of the information processing apparatus 2000.

The input unit 2008 includes an input control circuit that generates an input signal on the basis of an input from a user to output the input signal to the CPU 2001, and the like. In a case where the information processing apparatus 2000 is a personal computer, the input unit 2008 may include a keyboard, a mouse, and a touch panel, and may further include a camera and a microphone. Furthermore, the output unit 2009 includes a display device such as a liquid crystal display (LCD) device, an organic electro-luminescence (EL) display device, or a light emitting diode (LED), for example.

The storage unit 2010 stores files such as programs (application, OS, etc.) to be executed by the CPU 2001 and various pieces of data. Although the storage unit 2010 includes, for example, a mass storage device such as a solid state drive (SSD) or a hard disk drive (HDD), it may include an external storage device. The storage unit 2010 operates as, for example, at least one of the content holding unit 102, the metadata holding unit 103, or the foundation model unit 104.

A removable recording medium 2012 includes a cartridge-type storage medium such as a micro-SD card, for example. The drive 2011 performs reading and writing operations on a removable storage medium 113 loaded therein. The drive 2011 outputs data read from the removable recording medium 2012 to the RAM 2003 and the storage unit 2010, and writes data on the RAM 2003 and the storage unit 2010 to the removable recording medium 2012.

The communication unit 2013 is a device that performs wireless communication such as Wi-Fi (registered trademark), Bluetooth (registered trademark), or a cellular communication network such as 4G or 5G. Furthermore, the communication unit 2013 also include a terminal such as a universal serial bus (USB) or a high-definition multimedia interface (HDMI: registered trademark), and may further include a function of performing HDMI (registered trademark) communication with a USB device such as a scanner or a printer, a display, or the like.

### INDUSTRIAL APPLICABILITY

The present disclosure is described in detail with reference to the specific embodiments. However, the present disclosure should not be construed as being limited to the above-described embodiments, and those skilled in the art obviously can make modifications and substitutions of the embodiments without departing from the gist of the present disclosure. Furthermore, the effects described in the present specification are each merely an example, thus, the effects brought by an embodiment of the present disclosure are not limited and may include an additional effect that is not described herein.

In the present specification, the present disclosure has been described mainly with respect to an embodiment in which the tag is added to the music content, but the gist of the present disclosure is not limited thereto. Similarly, when a tag is added to content of various media such as moving image content, movie content, text content, or the like, the present disclosure is applied, so that a difference in interpretation is hardly generated with respect to the content, a new and sophisticated tag can be added, and a burden on the annotator can be reduced.

In short, the present disclosure is described in an illustrative manner, and the content disclosed in the present specification should not be interpreted in a limited manner. To determine the subject matter of the present disclosure, the claims should be taken into consideration.

The series of processing described in the present specification can be executed by hardware, software, or a configuration in which hardware and software are combined. In a case where the processing is executed by software, a program recorded with a processing sequence related to implementation of the present disclosure is installed and executed in a memory incorporated in dedicated hardware in a computer. It is also possible to install a program in a general-purpose computer capable of executing various types of processing and cause the computer to execute the processing related to implementation of the present disclosure.

The program can be preliminarily stored in a recording medium provided in the computer, such as an HDD, an SSD, or a ROM. Alternatively, the program can be temporarily or permanently stored in a removable recording medium such as a flexible disk, a compact disc read only memory (CD-ROM), a magneto optical (MO) disk, a digital versatile disc (DVD), a Blu-ray Disc (registered trademark) (BD), a magnetic disk, or a universal serial bus (USB) memory. Using such a removable recording medium enables a program related to implementation of the present disclosure as so-called package software to be provided.

Furthermore, the program may be transferred from a download site to a computer in a wireless or wired manner via a network such as a wide area network (WAN) typified by a cellular network, a local area network (LAN), or the Internet. The computer can receive the program thus transferred and cause the program to be installed in a mass storage device such as an HDD or an SSD in the computer.

Note that the present disclosure may also have the following configurations.
(1) An information processing apparatus including a new tag proposal unit that generates a new tag appropriate for content to which a tag is to be added on the basis of a foundation model and presents the new tag to an annotator.
(2) The information processing apparatus according to (1) described above, further including
an existing tag proposal unit that presents, to the annotator, an existing tag appropriate for content to which a tag is to be added from among existing tags, in which
the new tag proposal unit generates and presents a new tag in a case where the annotator does not select the existing tag presented by the existing tag proposal unit.
(3) The information processing apparatus according to (2)

described above, in which
the existing tag proposal unit estimates an existing tag appropriate for content to which a tag is to be added, using a learned model learned by using a sample with a correct answer label.
(4) The information processing apparatus according to any one of (2) or (3) described above, in which
the new tag proposal unit generates a plurality of candidates for a new tag, and selects and presents an expression that is semantically far from the tag presented by the existing tag proposal unit from among the plurality of candidates.
(5) The information processing apparatus according to any one of (1) to (4) described above, further including
a related content confirmation unit that presents content related to the tag to the annotator for confirmation.
(6) The information processing apparatus according to (5) described above, in which
when the annotator selects the new tag presented by the new tag proposal unit, the related content confirmation unit presents content related to the new tag to the annotator for confirmation.
(7) The information processing apparatus according to (6) described above, in which
the new tag is added to content selected by the annotator from among the content presented by the related content confirmation unit.
(8) The information processing apparatus according to (7) described above, in which
a model is learned from a plurality of pieces of the content to which the new tag is added so that the tag can be added as an existing tag.
(9) An information processing method including:
an existing tag proposal step of presenting, to an annotator, an existing tag appropriate for content to which a tag is to be added from among existing tags;
a new tag proposal step of generating, in a case where the annotator does not select the existing tag presented in the existing tag proposal step, a new tag appropriate for content to which a tag is to be added on the basis of a foundation model, and presenting the new tag to the annotator; and
a related content confirmation step of presenting content related to the new tag to the annotator for confirmation when the annotator selects the new tag presented in the new tag proposal step.
(10) A computer program described in a computer readable format, the computer program causing a computer to function as:
an existing tag proposal unit that presents, to an annotator, an existing tag appropriate for content to which a tag is to be added from among existing tags;
a new tag proposal unit that generates, in a case where the annotator does not select the existing tag presented by the existing tag proposal unit, a new tag appropriate for content to which a tag is to be added on the basis of a foundation model, and presents the new tag to the annotator; and
a related content confirmation unit that presents content related to the new tag to the annotator for confirmation.

### REFERENCE SIGNS LIST

100 Tag adding system
101 Terminal
102 Content holding unit
103 Metadata holding unit
104 Foundation model unit
105 Existing tag proposal unit
106 New tag proposal unit
107 Related content confirmation unit
2000 Information processing apparatus
2001 CPU
2002 ROM
2003 RAM
2004 Host bus
2005 Bridge
2006 Expansion bus
2007 Interface unit
2008 Input unit
2009 Output unit
2010 Storage unit
2011 Drive
2012 Removable recording medium
2013 Communication unit

1. An information processing apparatus comprising a new tag proposal unit that generates a new tag appropriate for content to which a tag is to be added on a basis of a foundation model and presents the new tag to an annotator.

2. The information processing apparatus according to claim 1, further comprising
an existing tag proposal unit that presents, to the annotator, an existing tag appropriate for content to which a tag is to be added from among existing tags, wherein
the new tag proposal unit generates and presents a new tag in a case where the annotator does not select the existing tag presented by the existing tag proposal unit.

3. The information processing apparatus according to claim 2, wherein
the existing tag proposal unit estimates an existing tag appropriate for content to which a tag is to be added, using a learned model learned by using a sample with a correct answer label.

4. The information processing apparatus according to claim 2, wherein
the new tag proposal unit generates a plurality of candidates for a new tag, and selects and presents an expression that is semantically far from the tag presented by the existing tag proposal unit from among the plurality of candidates.

5. The information processing apparatus according to claim 1, further comprising
a related content confirmation unit that presents content related to the tag to the annotator for confirmation.

6. The information processing apparatus according to claim 5, wherein
when the annotator selects the new tag presented by the new tag proposal unit, the related content confirmation unit presents content related to the new tag to the annotator for confirmation.

7. The information processing apparatus according to claim 6, wherein
the new tag is added to content selected by the annotator from among the content presented by the related content confirmation unit.

8. The information processing apparatus according to claim 7, wherein
a model is learned from a plurality of pieces of the content to which the new tag is added so that the tag can be added as an existing tag.

9. An information processing method comprising:
an existing tag proposal step of presenting, to an annotator, an existing tag appropriate for content to which a tag is to be added from among existing tags;
a new tag proposal step of generating, in a case where the annotator does not select the existing tag presented in the existing tag proposal step, a new tag appropriate for content to which a tag is to be added on a basis of a foundation model, and presenting the new tag to the annotator; and
a related content confirmation step of presenting content related to the new tag to the annotator for confirmation when the annotator selects the new tag presented in the new tag proposal step.

10. A computer program described in a computer readable format, the computer program causing a computer to function as:
an existing tag proposal unit that presents, to an annotator, an existing tag appropriate for content to which a tag is to be added from among existing tags;
a new tag proposal unit that generates, in a case where the annotator does not select the existing tag presented by the existing tag proposal unit, a new tag appropriate for content to which a tag is to be added on a basis of a foundation model, and presents the new tag to the annotator; and
a related content confirmation unit that presents content related to the new tag to the annotator for confirmation.
